(19) United States
(12) Patent Application Publication
(10) Pub. No.: US 2022/0082698 A1
(43) Pub. Date: Mar. 17, 2022

(54) DEPTH CAMERA AND MULTI-FREQUENCY MODULATION AND DEMODULATION-BASED NOISE-REDUCTION DISTANCE MEASUREMENT METHOD

(71) Applicant: ORBBEC INC., Shenzhen (CN)

(72) Inventor: Xing XU, SHENZHEN (CN)

(21) Appl. No.: 17/535,311

(22) Filed: Nov. 24, 2021

Related U.S. Application Data
(63) Continuation of application No. PCT/CN2019/097099, filed on Jul. 22, 2019.

(30) Foreign Application Priority Data
Jun. 14, 2019 (CN) 201910518105.9

(51) Int. Cl. G01S 17/894; G01S 7/4865; G01S 17/86

(52) U.S. Cl. CPC G01S 17/894; G01S 17/86; G01S 7/4865

(57) ABSTRACT

Provided are a time-of-flight depth camera and a noise-reduction distance measurement method. The depth camera comprises: a light source for emitting a pulse beam to an object to be measured; an image sensor comprising at least one pixel, wherein each of the at least one pixel comprises taps, and the taps are used for acquiring a charge signal generated by a reflected pulse beam reflected by the object to be measured and/or a charge signal of background light; and a processing circuit, configured to: control the taps to alternately acquire charge signals in frame periods of a macro period, wherein different modulation and demodulation frequencies are used in two adjacent macro periods; and receive data of charge signals acquired in the two adjacent macro periods to calculate a time of flight of the pulse beam and/or a distance from the depth camera to the object to be measured.

### CROSS-REFERENCE TO RELATED APPLICATIONS

This is a continuation of International Application No. PCT/CN2019/097099, filed on Jul. 22, 2019, which is based on and claims priority to and benefits of Chinese Patent Application No. 201910518105.9 filed on Jun. 14, 2019. The entire content of all of the above-identified applications is incorporated herein by reference.

### TECHNICAL FIELD

This application relates to the field of optical measurement technologies, and in particular, to a time-of-flight depth camera and a multi-frequency modulation and demodulation-based noise-reduction distance measurement method.

### BACKGROUND

A full name of TOF is Time-of-Flight, namely, a time of flight. A TOF distance measurement method is a technology that implements accurate distance measurement by measuring a round-trip time of flight of a light pulse between a transmission/receiving apparatus and a target object. In the TOF technology, a technology for directly measuring a time of flight of light is referred to as direct-TOF (dTOF). A measurement technology for periodically modulating a transmitted optical signal, measuring a phase delay of a reflected optical signal with respect to the transmitted optical signal, and then calculating a time of flight according to the phase delay is referred to as an indirect-TOF (iTOF) technology. Different types of modulation and demodulation include a continuous wave (CW) modulation and demodulation and a pulse modulated (PM) modulation and demodulation.

Currently, the CW-iTOF technology is mainly applicable to a measurement system constructed based on a two-tap sensor, and a core measurement algorithm is a four-phase modulation and demodulation manner, where at least two exposures are needed (to ensure the measurement precision, four exposures may be needed) to output one frame of depth image for acquisition of four-phase data to output one frame of a depth image. As a result, it is difficult to obtain a relatively high frame frequency. The PM-iTOF modulation technology is mainly applicable to a four-tap pixel sensor (three taps are used for acquisition and output of signals, and one tap is used for releasing invalid electrons). A measurement distance of this measurement manner is currently limited by a pulse width of a modulation and demodulation signal. When a long distance measurement needs to be performed, the pulse width of the modulation and demodulation signal needs to be extended, but the extension of the pulse width of the modulation and demodulation signal may increase power consumption and decrease measurement precision.

In addition, a multi-tap pixel sensor generally encounters a mismatch between taps or between readout circuits due to errors or other reasons in the manufacturing process, and consequently, fixed-pattern noise (FPN) is introduced, thereby further affecting the measurement precision.

### SUMMARY

To resolve the existing problems, this application provides a time-of-flight depth camera and a multi-frequency modulation and demodulation-based noise-reduction distance measurement method.

To resolve the above problems, the technical solutions adopted by this application are as follows.

A depth camera is provided. The depth camera includes: a light source for emitting a pulse beam to an object to be measured; an image sensor comprising at least one pixel, wherein each of the at least one pixel comprises a plurality of taps, and the plurality of taps are used for acquiring a charge signal generated by a reflected pulse beam reflected by the object to be measured and/or a charge signal of background light; and a processing circuit, configured to: control the plurality of taps to alternately acquire charge signals in a plurality of frame periods of a macro period, wherein different modulation and demodulation frequencies are used in two adjacent macro periods; and receive data of charge signals acquired in the two adjacent macro periods to calculate a time of flight of the pulse beam and/or a distance from the depth camera to the object to be measured.

In an embodiment of this application, the processing circuit is further configured to calculate the time of flight of the pulse beam in the macro period according to the following formula:

$$t = ( \frac{{Q}_{21} - {Q}_{31} + {Q}_{12} - {Q}_{22} + {Q}_{33} - {Q}_{13}}{{Q}_{21} + {Q}_{11} - 2 {Q}_{31} + {Q}_{12} + {Q}_{32} - 2 {Q}_{22} + {Q}_{33} + {Q}_{23} - 2 {Q}_{13}} ) Th$$

where Q₁₁, Q₂₁, Q₃₁, Q₁₂, Q₂₂, Q₃₂, Q₁₃, Q₂₃, and Q₃₃ respectively represent signals acquired by three taps of the plurality of taps in three consecutive frame periods of the plurality of frame periods.

In an embodiment of this application, the processing circuit is further configured to control an acquisition sequence of the plurality of taps to change continuously or control a time delay in emitting the pulse beam by the light source to allow the plurality of taps to alternately acquire the charge signals.

In an embodiment of this application, time delays between consecutive frame periods are increased regularly, or decreased regularly, or changed irregularly; and a difference between the time delays between the consecutive frame periods is an integer multiple of a pulse width of the pulse beam.

In an embodiment of this application, the processing circuit is further configured to identify the data of the charge signals to determine whether the data of the charge signals includes the charge signal of the reflected pulse beam, generate a judgment result, and then calculate the time of flight of the pulse beam and/or the distance from the depth camera to the object to be measured according to the judgment result.

This application further provides a distance measurement method, including: emitting, from a light source, a pulse beam to an object to be measured; acquiring, by an image sensor including at least one pixel, a charge signal of a reflected pulse beam reflected by the object to be measured, where each of the at least one pixel includes a plurality of taps, and the plurality of taps are used for acquiring the charge signal and/or a charge signal of background light; and controlling the plurality of taps to alternately acquire charge signals in a plurality of e frame periods of a macro period, where different modulation and demodulation frequencies are used in two adjacent macro periods; and receiving data of charge signals acquired in the two adjacent macro periods, to calculate a time of flight of the pulse beam and/or a distance from the depth camera to the object to be measured.

In an embodiment of this application, the time of flight of the pulse beam in a macro period is calculated according to the following formula:

$$t = ( \frac{{Q}_{21} - {Q}_{31} + {Q}_{12} - {Q}_{22} + {Q}_{33} - {Q}_{13}}{{Q}_{21} + {Q}_{11} - 2 {Q}_{31} + {Q}_{12} + {Q}_{32} - 2 {Q}_{22} + {Q}_{33} + {Q}_{23} - 2 {Q}_{13}} ) Th$$

where Q₁₁, Q₂₁, Q₃₁, Q₁₂, Q₂₂, Q₃₂, Q₁₃, Q₂₃, and Q₃₃ respectively represent signals acquired by three taps of the plurality of taps in three consecutive frame periods of the plurality of frame periods.

In an embodiment of this application, the controlling the plurality of taps to alternately acquire charge signals in a plurality of frame periods of a macro period comprises: controlling an acquisition sequence of the plurality of taps to change continuously or controlling a time delay in emitting the pulse beam by the light source to allow the plurality of taps to alternately acquire the charge signals.

In an embodiment of this application, time delays between consecutive frame periods are regularly increased, regularly decreased, or irregularly changed; and a difference between the time delays between the consecutive frame periods is an integer multiple of a pulse width of the pulse beam.

In an embodiment of this application, the method further includes identifying the data of the charge signals to determine whether the data of the charge signals includes the charge signal of the reflected pulse beam, generating a judgment result, and then calculating the time of flight of the pulse beam and/or the distance from the depth camera to the object to be measured according to the judgment result.

The beneficial effects of this application are: a time-of-flight depth camera and a multi-frequency modulation and demodulation-based noise-reduction distance measurement method are provided, to resolve a conflict in an existing PM-iTOF measurement solution that the pulse width is in direct proportion to a measurement distance and power consumption, but is negatively correlated with the measurement precision. Therefore, the extension of the measurement distance is no longer limited by the pulse width. In a case of a longer measurement distance, lower measurement power consumption and higher measurement precision may still be retained. In addition, fixed-pattern noise (FPN) caused by a mismatch between taps or between readout circuits due to manufacturing process errors or other reasons may be reduced or eliminated by alternating taps for acquisition. Compared with the CW-iTOF measurement solution, in this solution, for a single group of modulation and demodulation frequencies, one frame of depth information may be obtained by outputting a signal amount of three taps through one exposure, thereby significantly reducing the entire measurement power consumption and improving the measurement frame frequency. Therefore, this solution has apparent advantages compared with existing iTOF technical solutions.

### BRIEF DESCRIPTION OF THE DRAWINGS

FIG. 1 is a schematic diagram illustrating the principles of a time-of-flight depth camera, according to an embodiment of this application.

FIG. 2 is a schematic timing diagram of an optical signal transmission and acquisition method for a time-of-flight depth camera, according to an embodiment of this application.

FIG. 3 is a schematic timing diagram of a noise-reduction optical signal transmission and acquisition method for a time-of-flight depth camera, according to an embodiment of this application.

FIG. 4 is a schematic timing diagram of another noise-reduction optical signal transmission and acquisition method for a time-of-flight depth camera, according to an embodiment of this application.

FIG. 5 is a flow chart of a single-frequency modulation and demodulation-based noise-reduction distance measurement method, according to an embodiment of this application.

FIG. 6 is a schematic timing diagram of another optical signal transmission and acquisition method for a time-of-flight depth camera, according to an embodiment of this application.

FIG. 7 shows a two-consecutive-frame postponement acquisition method, according to an embodiment of this application.

FIG. 8(a) shows another two-consecutive-frame postponement acquisition method, according to an embodiment of this application.

FIG. 8(b) shows still another two-consecutive-frame postponement acquisition method, according to an embodiment of this application.

FIG. 9 is a flow chart of a multi-frequency modulation and demodulation-based noise-reduction distance measurement method, according to an embodiment of this application.

### DETAILED DESCRIPTION

To make the technical problems to be resolved by the embodiments of this application, and the technical solutions and beneficial effects of the embodiments of this application clearer and more comprehensible, the following further describes this application in detail with reference to the accompanying drawings and embodiments. It should be understood that the specific embodiments described herein are merely used for explaining this application but do not limit this application.

It should be noted that, when an element is described as being “fixed on” or “disposed on” another element, the element may be directly located on the another element, or indirectly located on the another element. When an element is described as being “connected to” another element, the element may be directly connected to the another element, or indirectly connected to the another element. In addition, the connection may be used for fixation or circuit connection.

It should be understood that orientation or position relationships indicated by terms such as “length,” “width,” “above,” “below,” “front,” “back,” “left,” “right,” “vertical,” “horizontal” “top,” “bottom,” “inside,” and “outside” are based on orientation or position relationships shown in the accompanying drawings, and are used only for ease and brevity of illustration and description of the embodiments of this application, rather than indicating or implying that the mentioned apparatus or element needs to have a particular orientation or needs to be constructed and operated in a particular orientation. Therefore, such terms should not be construed as limiting this application.

In addition, terms “first” and “second” are used merely for the purpose of description, and shall not be construed as indicating or implying relative importance or implying a quantity of indicated technical features. In view of this, a feature defined by “first” or “second” may explicitly or implicitly include one or more features. In the descriptions of the embodiments of this application, unless otherwise specified, “a plurality of” means two or more than two.

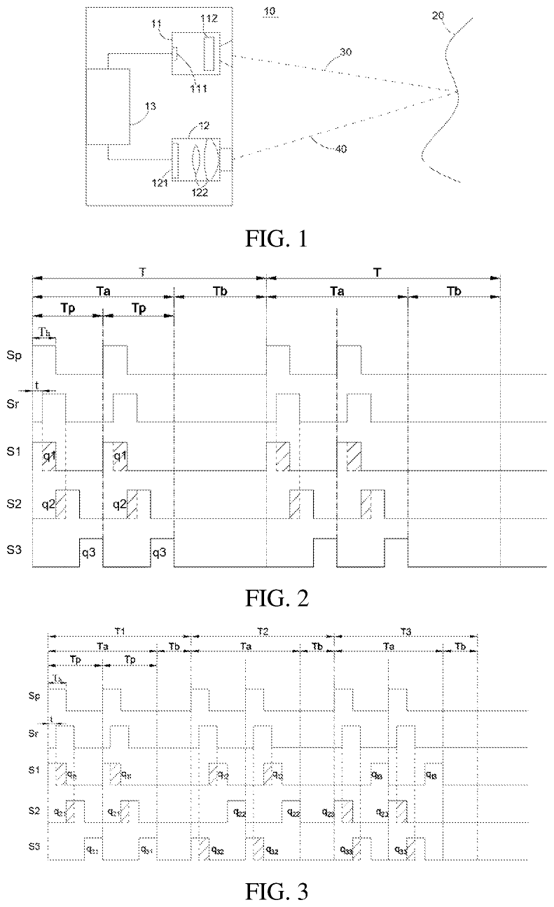

FIG. 1 is a schematic diagram illustrating the principles of a time-of-flight depth camera, according to an embodiment of this application. The time-of-flight depth camera 10 includes an emitting module 11, an acquisition module 12, and a processing circuit 13. The emitting module 11 provides an emitted beam 30 to a target space to illuminate an object 20 in the space. At least a portion of the emitted beam 30 is reflected by the object 20 to form a reflected beam 40, and at least a portion of the reflected beam 40 is acquired by the acquisition module 12. The processing circuit 13 is respectively connected to the emitting module 11 and the acquisition module 12. Trigger signals of the emitting module 11 and the acquisition module 12 are synchronized to calculate a time required for the beam to be emitted by the emitting module 11 and received by the acquisition module 12, that is, a time of flight (TOF) t of the emitted beam 30 and the reflected beam 40. Further, a total light flight distance D to a corresponding point on the object can be calculated by the following formula:

$$D = c \cdot t \qquad ( 1 )$$

where c is a speed of light.

The emitting module 11 includes a light source 111, a beam modulator 112, and a light source driver (not shown in the figure). The light source 111 may be a light source such as a light emitting diode (LED), an edge emitting laser (EEL), or a vertical cavity surface emitting laser (VCSEL), or may be a light source array including a plurality of light sources. A beam emitted by the light source may be visible light, infrared light, ultraviolet light, or the like. The light source 111 emits a beam under the control of the light source driver (which may be further controlled by the processing circuit 13). For example, in an embodiment, the light source 111 is controlled to emit a pulse beam at a certain frequency, which can be used in a direct TOF measurement method, where the frequency is set according to a to-be-measured distance, for example, set to 1 MHz to 100 MHz. The to-be-measured distance may range from several meters to several hundred meters. In an embodiment, an amplitude of the beam emitted by the light source 111 is modulated so that the light source 111 emits a beam such as a pulse beam, a square wave beam, or a sine wave beam, which can be used in an indirect TOF measurement method. It may be understood that the light source 111 may be controlled to emit a beam by a portion of the processing circuit 13 or a sub-circuit independent of the processing circuit 13, such as a pulse signal generator.

The beam modulator 112 receives the beam from the light source 111, and emits a spatial modulated beam, for example, a flood beam with a uniform intensity distribution or a patterned beam with a nonuniform intensity distribution. It may be understood that, the uniform distribution herein is a relative concept rather than absolutely uniform. Generally, the beam intensity in an edge of a field of view (FOV) may be lower. In addition, the intensity in the middle of an imaging region may change within a certain threshold, for example, an intensity change not exceeding a value such as 15% or 10% may be permitted. In some embodiments, the beam modulator 112 is further configured to expand the received beam, to increase an FOV angle.

The acquisition module 12 includes an image sensor 121 and a lens unit 122, and may further include a light filter (not shown in the figure). The lens unit 122 receives at least a portion of the spatial modulated beam reflected by the object, and images the at least a portion of the spatial modulated beam on the image sensor 121. A narrow-band light filter matching a wavelength of the light source may be selected as the light filter to restrain background light noise of other wave bands. The image sensor 121 may include one or more a charge coupled device (CCD), a complementary metal oxide semiconductor (CMOS), an avalanche diode (AD), a single-photon avalanche diode (SPAD), and the like. An array size of the image sensor 121 represents a resolution, such as 320×240, of the depth camera. Generally, a readout circuit (not shown in the figure) including one or more of devices such as a signal amplifier, a time-to-digital converter (TDC), and an analog-to-digital converter (ADC) is further connected to the image sensor 121.

Generally, the image sensor 121 includes at least one pixel, and each pixel includes a plurality of taps (which are used for storing and reading or releasing charge signals generated by incident photons under the control of a corresponding electrode). For example, three taps may be included for reading data of the charge signals.

In some embodiments, the time-of-flight depth camera 10 may further include devices such as a driving circuit, a power supply, a color camera, an infrared camera, and an inertial measurement unit (IMU), which are not shown in the figure. Combinations with such devices can achieve more abundant functions, such as 3D texture modeling, infrared face recognition, and simultaneous localization and mapping (SLAM). The time-of-flight depth camera 10 may be included in an electronic product such as a mobile phone, a tablet computer, or a computer.

The processing circuit 13 may be an independent dedicated circuit, for example, a dedicated SOC chip, FPGA chip, or ASIC chip including a CPU, a memory, a bus, and the like, or may include a general processing circuit. For example, when the depth camera is integrated in a smart terminal such as a mobile phone, a television, or a computer, a processing circuit in the terminal may be used as at least a portion of the processing circuit 13. In some embodiments, the processing circuit 13 is configured to provide a modulation signal (transmission signal) required by the light source 111 for emitting a laser, and the light source emits a pulse beam to an object to be measured under the control of the modulation signal. In addition, the processing circuit 13 further provides a demodulation signal (acquisition signal) for taps in each pixel of the image sensor 121, and the taps acquire, under the control of the demodulation signal, charge signals generated by beams including a pulse beam reflected by the object to be measured. Generally, the beams may also include background light and disturbance light besides the reflected pulse beam reflected by the object to be measured. The processing circuit 13 may further provide an auxiliary monitoring signal, such as a temperature sensing signal, an overcurrent or overvoltage protection signal, or a drop protection signal. The processing circuit 13 may be further configured to save original data acquired by the taps in the image sensor 121 and perform corresponding processing, to obtain specific position information of the object to be measured. The modulation and demodulation method and functions of control and processing that are executed by the processing circuit 13 will be described in detail in embodiments of FIG. 2 to FIG. 8. For ease of description, a PM-iTOF modulation and demodulation method is used as an example.

FIG. 2 is a schematic timing diagram of an optical signal transmission and acquisition method for a time-of-flight depth camera, according to an embodiment of this application. FIG. 2 shows a schematic diagram of a sequence of a laser transmission signal (modulation signal), a receiving signal, and an acquisition signal (demodulation signal) in two frame periods 2T. Sp represents pulse transmission signals of the light source, and each pulse transmission signal represents one pulse beam. Sr represents reflected optical signals reflected by an object. Each reflected optical signal represents a corresponding pulse beam reflected by the object to be measured, which has a certain delay relative to the pulse transmission signal in a timeline (the horizontal axis in the figure), and a delayed time t is the time of flight of the pulse beam that needs to be calculated. S1 represents pulse acquisition signals of a first tap in a pixel, S2 represents pulse acquisition signals of a second tap in the pixel, S3 represents pulse acquisition signals of a third tap in the pixel, and each pulse acquisition signal represents a charge signal (electrons) generated by the pixel in a time segment corresponding to the signal and acquired by the tap, and Tp=N×Th, where N is a quantity of taps participating in pixel electron acquisition, and N=3 in the embodiment shown in FIG. 2.

The entire frame period T is divided into two time segments Ta and Tb, where Ta represents a time segment in which the taps of the pixel perform charge acquisition and storage, and Tb represents a time segment in which charge signals are read out. In the charge acquisition and storage time segment Ta, an acquisition signal pulse of an nth tap has a (n−1)×Th phase delay time with respect to a laser transmission signal pulse. When the reflected optical signal is reflected by the object to the pixel, each tap acquires electrons generated on the pixel within a corresponding pulse time segment of the pixel. In this embodiment, the acquisition signal and the laser transmission signal of the first tap are triggered synchronously. When the reflected optical signal is reflected by the object to the pixel, the first tap, the second tap, and the third tap each perform charge acquisition and storage sequentially, to obtain charge quantities q1, q2, and q3, respectively, so as to complete a pulse period Tp, and Tp=3Th for a case of three taps. In the embodiment shown in FIG. 2, two pulse periods Tp are included in a single frame period, and a laser pulse signal is emitted twice in total. Therefore, a total charge quantity acquired and read out by the taps in the time segment Tb is a sum of charge quantities corresponding to optical signals acquired twice. It may be understood that, in a single frame period, a quantity of pulse periods Tp or a quantity of times that the laser pulse signal is emitted may be K, where K is not less than 1, or may be up to tens of thousands or even higher, and a specific quantity may be determined according to an actual requirement. In addition, quantities of pulses in different frame periods may also be different.

Therefore, the total charge quantity acquired and read out by the taps in the time segment Tb is a sum of charge quantities corresponding to optical signals acquired by the taps for a plurality of times in the entire frame period T. The total charge quantity of the taps in a single frame period may be represented as follows:

$$Qi = Σ qi , i = 1 , 2 , 3 \qquad ( 2 )$$

According to formula (2), the total charge quantities of the first tap, the second tap, and the third tap in a single frame period are Q1, Q2, and Q3, respectively.

In a conventional modulation and demodulation manner, a measurement range is limited within a single-pulse-width time Th. That is, it is assumed that the reflected optical signal is acquired by the first tap and the second tap (the first tap and the second tap may also acquire an ambient light signal simultaneously), and the third tap is used for acquiring the ambient light signal. In this way, based on the total charge quantities acquired by the taps, a processing unit may calculate, according to the following formula, a total light flight distance of a pulse optical signal from being transmitted at the light source to being received at the pixel:

$$D = cT = c ( \frac{Q 2 - Q 3}{Q 1 + Q 2 - 2 Q 3} ) Th \qquad ( 3 )$$

Further, spatial coordinates of a target may be then calculated according to optical and structural parameters of the camera.

The conventional modulation and demodulation manner has an advantage of simple calculation, but has a disadvantage of limited measurement range, where a measured TOF is limited within Th, and a corresponding maximum flight distance measurement range is limited within c×Th.

To increase a measurement distance, this application provides a new modulation and demodulation method. FIG. 2 is a schematic timing diagram of optical signal transmission and acquisition, according to an embodiment of this application. In this case, the reflected optical signal may not only fall onto the first tap and the second tap, may be also permitted to fall onto the second tap and the third tap, and may be even permitted to fall onto the third tap and a first tap in a next pulse period Tp (for a case that there are at least two pulse periods Tp). The “fall onto a tap” herein means that the signal may be acquired by the tap. The total charge quantities read within the time segment Tb are Q1, Q2, and Q3, and different from the conventional modulation and demodulation manner. In this application, taps for receiving the reflected optical signals and periods are not limited.

Considering that a charge quantity acquired by a tap receiving the reflected optical signal is greater than that acquired by a tap receiving only background light signals, the processing circuit evaluates the three obtained total charge quantities Q1, Q2, and Q3, to determine taps that acquire excitation electrons of the reflected optical signal and/or taps that acquire only background signals. During actual use, interference from electrons between taps may exist, for example, some reflected optical signals may enter the taps originally used for obtaining background signals only, and these errors may be permitted, which also falls within the protection scope of this solution. Assuming that after the evaluation, two total charge quantities of the reflected light signals are denoted sequentially (according to the order of receiving the reflected optical signals) as QA and QB, and a total charge quantity including only the background light signals is denoted as QO. A three-tap image sensor may have following three possibilities:

(1) QA=Q1, QB=Q2, and QO=Q3;

(2) QA=Q2, QB=Q3, and QO=Q1; and

(3) QA=Q3, QB=Q1 (of a next pulse period Tp), and QO=Q2.

The processing circuit may then calculate a TOF of the optical signal according to the following formula:

$$t = ( \frac{QB - QO}{QA + QB - 2 QO} + m ) Th \qquad ( 4 )$$

where m in the formula reflects a delay of a tap onto which the reflected optical signal falls for the first time with respect to the first tap, and m is respectively 0, 1, and 2 for the foregoing three cases. That is, if the reflected optical signal first falls onto an n^{th} tap, m=n−1. n refers to a serial number of a tap corresponding to QA, and a phase delay time of the tap whose serial number is n relative to a transmitted optical pulse signal is (n−1)×Th, where Th is a pulse width of a pulse acquisition signal of each tap. Tp is a pulse period, and Tp=N×Th, where N is a quantity of taps participating in pixel electron acquisition.

Comparing formula (4) with formula (3), it can be learned that the measurement distance is extended, and the maximum measurement flight distance is enlarged from c×Th in the conventional method to c×Tp=c×N×Th in this application, where N is the quantity of taps participating in the acquisition of pixel electrons, and a value of N in this example is 3. Therefore, compared with the conventional modulation and demodulation method, this method implements a measurement distance that is three times that of the conventional method through an evaluation mechanism.

The key of the foregoing modulation and demodulation method is how to determine a tap onto which the reflected optical signal falls. In this regard, this application provides the following determination methods.

(1) Single-tap maximization method. Obtaining a tap (denoted by Nodeₓ) having a maximum output signal (total charge quantity) by searching from a tap 1 to a tap N (N=3 in the foregoing embodiment) according to a sequence of Node₁→Node₂→ . . . →Node_{N}→Node₁→ . . . , where a previous tap of Nodeₓ is denoted by Node_{w} and a next tap of Node is denoted by Node_{y}. If total charge quantities of Node_{w} and Node_{y} are Q_{w}≥Q_{y}, Node is a tap A; and if Q_{w}<Q_{y}, Node is the tap A.

(2) Adjacent-tap sum maximization method. A sum of total charge quantities of adjacent taps is first calculated according to a sequence Node₁→Node₂→ . . . →Node_{N}→Node₁→ . . . , that is, Sum₁=Q₁+Q₂, Sum₂=Q₂+Q₃, . . . , Sum_{N}=Q_{N}+Q₁. If a maximum sum is found as Sumₙ, a tap n is the tap A, and a next tap of the tap n is the tap B.

After the taps A and B are determined, there are at least four methods for calculating a background signal quantity.

(1) Background after B: taking a signal quantity of a tap after the tap B as the background signal quantity.

(2) Background before A: taking a signal quantity of a tap before the tap A as the background signal quantity.

(3) Average background: taking an average value of signal quantities of all taps except the taps A and B as the background signal quantity.

(4) Average background after being reduced by 1: taking an average value of signal quantities of all taps except the taps A and B and a next tap of the tap B as the background signal quantity.

It should be noted that, when N=3, namely, there are only 3 taps, the method (4) may be unworkable, and the methods (1) to (3) are equivalent. When k=4, the methods (3) and (4) are equivalent, and to reduce the interference of the signal quantity as much as possible, the method (3) may be preferred over method (4). When k>4, the method (4) may be preferred over the method (3).

A 3-tap pixel-based modulation and demodulation method is described in the foregoing embodiment. It may be understood that, this modulation and demodulation method is also applicable to a pixel with more taps, namely, N>3. For example, a measurement distance of which a maximum value is 4Th may be implemented for a 4-tap pixel, and a measurement distance of which a maximum value is 5Th may be implemented for a 5-tap pixel. Compared with the conventional PM-iTOF measurement solution, this measurement method expands the longest measurement TOF from the pulse width time Th to the entire pulse period Tp, which is referred to as a single-frequency full-period measurement solution herein.

In the analysis of the foregoing embodiment, the charge quantities acquired by the taps and TOF calculation formulas are all directed to an ideal case. However, in an actual case, fixed-pattern noise (FPN) may be caused by a mismatch between pixels due to manufacturing process errors or a mismatch between ADCs of the taps, such as a difference between gains of the taps or different offsets of circuits of the ADCs of the taps, resulting in a measurement error.

To resolve this problem, this application provides a noise-reduction measurement method. FIG. 3 is a schematic timing diagram of a noise-reduction optical signal transmission and acquisition method for a time-of-flight depth camera, according to an embodiment of this application. FIG. 3 shows a schematic timing diagram of modulation and demodulation signals in three consecutive frame periods T1, T2, and T3. The three consecutive frame periods are used as a macro period unit of this solution, which means that the modulation and demodulation signals are continuously cycled in a macro period T1, T2, T3, T1, T2, T3, T1, . . . in sequence. In three consecutive frame periods Ti (i is equal to 1, 2, or 3) of a single macro period unit, the processing circuit controls an acquisition sequence (acquisition phase) of each tap to change continuously, to enable the three taps to alternately acquire charge signals. For example, in the embodiment shown in FIG. 3, in the period T1, in each pulse period Tp, the three taps sequentially acquire charge signals within time segments 0 to ⅓ Tp (0 to 120°), ⅓ Tp to ⅔ Tp (120° to 240°), and ⅔ Tp to Tp (240 to 360°) according to a sequence S1-S2-S3. In a period T2, in each pulse period Tp, the three taps sequentially acquire charge signals within time segments 0 to ⅓ Tp (0 to 120°), ⅓ Tp to ⅔ Tp (120° to 240°), and ⅔ Tp to Tp (240° to) 360° according to a sequence S3-S1-S2. In a period T3, in each pulse period Tp, the three taps sequentially acquire charge signals within time segments 0 to ⅓ Tp (0 to 120°), ⅓ Tp to ⅔ Tp (120° to 240°), and ⅔ Tp to Tp (240° to 360°) according to a sequence S2-S3-S1.

It may be understood that, in each frame period, the acquisition sequence of the taps may be changed according to, but not limited to, the foregoing sequential alternation manner. Any alternation manner may be used as long as that the acquisition sequence of the taps may achieve the alternate acquisition.

Generally, for an N-tap pixel, a single macro period unit may include at least N frame periods, to ensure that each tap may implement a complete alternating acquisition. For example, in the embodiment shown in FIG. 3, for a 3-tap pixel, a single macro period unit includes 3 or more frame periods. In an embodiment, 3n frame periods, i.e., an integer multiple of the tap quantity, may be included. Other quantities of frame periods may also be included according to an actual requirement. In addition, the N frame periods in the macro period unit may not be consecutive in sequence. For example, in an embodiment, a plurality of frame periods included in two or more macro periods may overlap with each other.

Assuming in an ideal case, charge signals sequentially acquired by three taps are QO, Q120, and Q240, respectively. Actually, due to the existence of the FPN, signals acquired by the taps in three consecutive frame periods are Q11, Q21, Q31, Q12, Q22, Q32, Q13, Q23, and Q33, respectively, where Qᵢⱼ=Σqᵢⱼ, i represents a tap index and is equal to 1, 2, or 3, and j represents a period index and is equal to 1, 2, or 3. In addition, Q=GQ+O, where G and O respectively represent a gain and an offset of a corresponding tap. For example, for the period T1 in FIG. 3:

$${Q}_{11} = {G}_{1} {Q}_{O} + {O}_{1} , {Q}_{21} = {G}_{2} {Q}_{120} + {O}_{2} , {Q}_{31} = {G}_{3} {Q}_{240} + {O}_{3} \qquad ( 5 )$$

For the period T2 in FIG. 3:

$${Q}_{12} = {G}_{1} {Q}_{120} + {O}_{1} , {Q}_{22} = {G}_{2} {Q}_{240} + {O}_{2} , {Q}_{32} = {G}_{3} {Q}_{O} + {O}_{3} \qquad ( 6 )$$

For the period T3 in FIG. 3:

$${Q}_{13} = {G}_{1} {Q}_{240} + {O}_{1} , {Q}_{23} = {G}_{2} {Q}_{O} + {O}_{2} , {Q}_{33} = {G}_{3} {Q}_{120} + {O}_{3} \qquad ( 7 )$$

To reduce the FPN, this solution uses charge signals acquired from the three consecutive frames to calculate a TOF value (or a depth value) of a single frame. For ease of analysis, assuming that the reflected optical signal falls onto taps corresponding to time segments 0 to ⅓ Tp (0 to 0°) and ⅓ Tp to ⅔ Tp (0° to 120°), a calculation formula is as follows:

$$t = ( \frac{{Q}_{21} - {Q}_{31} + {Q}_{12} - {Q}_{22} + {Q}_{33} - {Q}_{13}}{{Q}_{21} + {Q}_{11} - 2 {Q}_{31} + {Q}_{12} + {Q}_{32} - 2 {Q}_{22} + {Q}_{33} + {Q}_{23} - 2 {Q}_{13}} ) Th \qquad ( 8 )$$

If the single-frequency full-period measurement solution shown in FIG. 2 is taken into consideration, a calculation formula is as follows:

$$t = ( \frac{{Q}_{21} - {Q}_{31} + {Q}_{12} - {Q}_{22} + {Q}_{33} - {Q}_{13}}{{Q}_{21} + {Q}_{11} - 2 {Q}_{31} + {Q}_{12} + {Q}_{32} - 2 {Q}_{22} + {Q}_{33} + {Q}_{23} - 2 {Q}_{13}} + m ) Th \qquad ( 9 )$$

Analysis is performed by selecting a case corresponding to formula (8) as an example, and formulas (5) to (7) are substituted into formula (8):

$$\begin{matrix}t = ( \frac{{Q}_{21} - {Q}_{31} + {Q}_{22} - {Q}_{32} + {Q}_{23} - {Q}_{33}}{{Q}_{21} + {Q}_{11} - 2 {Q}_{31} + {Q}_{22} + {Q}_{12} - 2 {Q}_{32} + {Q}_{23} + {Q}_{13} - 2 {Q}_{33}} ) Th \\ = ( \frac{\begin{matrix}{G}_{2} {Q}_{120} + {O}_{2} - {G}_{2} {Q}_{240} - {O}_{3} + {G}_{1} {Q}_{120} + \\ {O}_{1} - {G}_{2} {Q}_{240} - {O}_{2} + {G}_{3} {Q}_{120} + {O}_{3} - {G}_{1} {Q}_{240} - {O}_{1}\end{matrix}}{\begin{matrix}\begin{matrix}{G}_{2} {Q}_{120} + {O}_{2} + {G}_{1} {Q}_{O} + {O}_{1} - 2 ( {G}_{3} {Q}_{240} + {O}_{3} ) + \\ {G}_{1} {Q}_{120} + {O}_{1} + {G}_{3} {Q}_{O} + {O}_{3} - 2 ( {G}_{2} {Q}_{240} + {O}_{2} ) +\end{matrix} \\ {G}_{3} {Q}_{120} + {O}_{3} + {G}_{2} {Q}_{O} + {O}_{2} - 2 ( {G}_{1} {Q}_{240} + {O}_{1} )\end{matrix}} ) Th \\ = ( \frac{( {G}_{1} + {G}_{2} + {G}_{3} ) ( {Q}_{120} - {Q}_{240} )}{( {G}_{1} + {G}_{2} + {G}_{3} ) ( {Q}_{0} + {Q}_{120} - {Q}_{240} )} ) Th = ( \frac{{Q}_{120} - {Q}_{240}}{{Q}_{0} + {Q}_{120} - {Q}_{240}} ) Th\end{matrix} \qquad ( 10 )$$

According to formula (10), a TOF calculated with the data of 3 consecutive frames is not affected by neither the gain G nor the offset 0, thereby theoretically eliminating errors caused by the FPN.

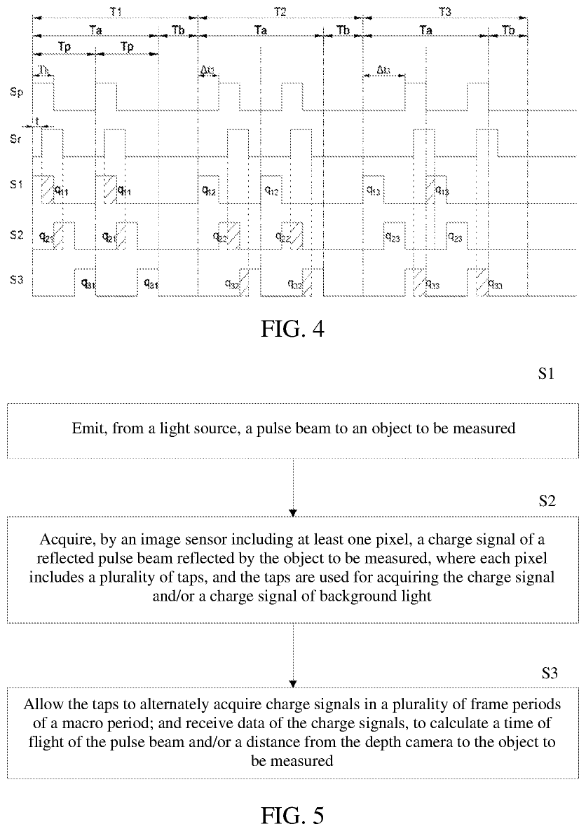

FIG. 4 is a schematic timing diagram of a noise-reduction optical signal transmission and acquisition method for a time-of-flight depth camera, according to another embodiment of this application. To reduce noise, in the embodiment shown in FIG. 3, the acquisition sequence of taps in each frame period of a macro period unit is changed to implement the alternate acquisition. However, during an actual application, it is relatively difficult to constantly change the acquisition sequence of taps. In the embodiment of this application, the said problem can be solved by controlling a pulse transmission time. Similarly, using the 3 taps as an example, a single macro period may include three frame periods T1, T2, and T3. In each frame period, the processing circuit controls emitting pulse beams with time delays according to a certain sequence to implement alternate acquisition of charge signals by the taps. In this embodiment, in the frame periods T1, T2, and T3, the pulse beams are emitted with time delays of Δt1, Δt2, and Δt3, respectively, where Δti=(i−1)Th (i is equal to 1, 2, or 3). In this embodiment, the minimum time delay Δt1 is 0 and therefore is not marked in the figure. In other embodiments of this application, the minimum delay may not be 0.

In FIG. 4, in the frame period T3, a reflected pulse signal enters the second pulse period Tp, causing that a single tap acquires charge signals in the first pulse period. However, there are actually thousands to tens of thousands of pulse periods, so that this error may be ignored.

It may be understood that, in consecutive frame periods of a single macro period, the time delays of the pulse beams may not increase regularly (i.e., the time delay increases by a same constant Δt with respect to the previous time delay) as shown in the embodiment shown in FIG. 4, for example, decrease regularly (i.e., the time delay decreases by a same constant Δt with respect to the previous time delay), or change irregularly (i.e., the time delay decreases/increase by a varied Δt with respect to the previous time delay.) In addition, the minimum time delay may not be 0, and a different between the time delays may not be a single pulse width and may be an integer multiple of the pulse width, such as two pulse widths.

As can be seen from FIG. 4, by applying a time delay to the pulse beam, the alternate acquisition of charge signals by the taps in frame periods of a single macro period can be implemented without changing the acquisition sequence of the taps. The TOF may also be calculated using formulas (5) to (10), and the FPN noise may also be reduced.

The 3-tap pixel-based noise-reduction modulation and demodulation method is described in the embodiments shown in FIG. 3 and FIG. 4. It may be understood that, this modulation and demodulation method is also applicable to a pixel with more taps, namely, N>3. For example, for a 4-tap pixel, a single macro period unit includes 4 consecutive frame periods. In each period, the processing circuit controls to constantly change the acquisition sequence of the taps or to emit pulse beams with time delays according to a certain sequence, to enable the taps to alternately acquire charge signals, thereby reducing noise.

The single-frequency full-period measurement solution provided in the embodiment shown in FIG. 2 is also applicable to the noise-reduction measurement solution shown in FIG. 3 or FIG. 4. That is, the charge signals measured by the taps are evaluated to determine whether data of the acquired charge signals includes the charge signal of the reflected pulse beam, to determine a value of each charge quantity Q in formula (9) and to calculate the TOF based on formula (9).

FIG. 5 shows a flow chart of a single-frequency modulation and demodulation-based noise-reduction distance measurement method, including the following steps.

S1: emitting, from a light source, a pulse beam to an object to be measured;

S2: acquiring, by an image sensor including at least one pixel, a charge signal of a reflected pulse beam reflected by the object to be measured, where each pixel includes a plurality of taps, and the taps are used for acquiring the charge signal and/or a charge signal of background light; and

S3: controlling the taps to alternately acquire charge signals in a plurality of frame periods of a macro period; and receiving data of the charge signals, to calculate a time of flight of the pulse beam and/or a distance from the depth camera to the object to be measured.

The single-frequency full-period measurement solution may increase the measurement distance to some extent, but still cannot implement measurement with a longer distance. For example, according to the 3-tap pixel-based modulation and demodulation method, when a TOF corresponding to a distance to the object exceeds 3Th, the reflected optical signal in one pulse period Tp may first fall onto a tap of a subsequent pulse period. In this case, the TOF or the distance cannot be measured accurately by using formula (3) or formula (4). For example, when the reflected optical signal in one pulse period Tp first falls onto an n^{th} tap in a subsequent j^{th} pulse period, a TOF of a real object corresponding to the optical signal is represented in the following formula:

$$t = ( \frac{QB - QO}{QA + QB - 2 QO} + m ) Th + j \cdot Tp \qquad ( 11 )$$

where m=n−1, and n is a serial number of a tap corresponding to QA. Since the total charge quantity of each tap is obtained by integrating charges accumulated in related pulse periods, a specific value of j cannot be recognized merely from the outputted total charge quantity of each tap, leading to a confusion of the distance measurement.

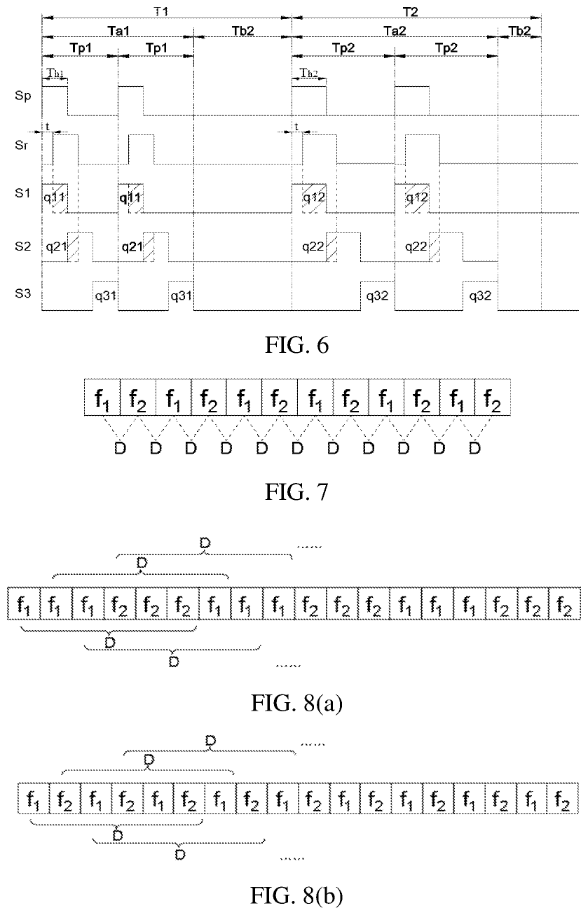

FIG. 6 is a schematic timing diagram of optical signal transmission and acquisition method for a time-of-flight depth camera, according to another embodiment of this application, which may be used for resolving the foregoing confusion problem. Different from the embodiment shown in FIG. 2, this embodiment adopts a multi-frequency modulation and demodulation method, namely, the processing circuit controls to use different modulation and demodulation frequencies in adjacent frames. For ease of description, in this embodiment, two adjacent frame periods are used as an example for description. In the adjacent frame periods, K is a quantity of times that a pulse is transmitted, K may equal to 2 (or more and may vary due to different quantities of frames), N is a quantity of taps of a pixel, N may equal to 3, pulse periods Tpi are Tp1 and Tp2 respectively, pulse widths Thi are Th1 and Th2 respectively, pulse frequencies or modulation and demodulation frequencies are f1 and f2 respectively, and charges accumulated by the three taps of each pulse are q₁₁, q₁₂, q₂₁, q₂₂, q₃₁, and q₃₂ respectively, and total charge quantities may be obtained as Q₁₁, Q₁₂, Q₂₁, Q₂₂, Q₃₁, and Q₃₂ according to formula (2).

Assuming that the distance from the camera to an object in adjacent frame (or a plurality of consecutive frame) periods is not changed, tin the adjacent frame periods is the same. After the total charge quantities of the taps are received, the processing circuit uses the modulation and demodulation method shown in FIG. 2 to measure the distance d (or time t) in each frame period, and calculates QAi, QBi, and QOi in each frame period according to the foregoing determination method, where i represents an i^{th} frame period and is equal to 1 or 2 in this embodiment. To enlarge a measurement range, the reflected optical signal is permitted to fall onto a tap in a subsequent pulse period. If a reflected optical signal on one pixel in an i^{th} frame period first falls onto an mi^{th} tap in a ji^{th} pulse period after a pulse period in which a transmitted pulse is located (the pulse period in which the transmitted pulse is located is a 0^{th} pulse period after a to-be-emitted pulse beam is emitted), a corresponding TOF may be represented according to formula (11) as follows:

$$ti = ( \frac{QBi - QOi}{QAi + QBi - 2 QOi} + mi ) Thi + ji \cdot Tpi \qquad ( 12 )$$

Considering that the distance to the object in adjacent frame periods is not changed, the following formula is established for a case of two consecutive frames in this embodiment:

$$( x 1 + m 1 ) Th 1 + j 1 \cdot Tp 1 = ( x 2 + m 2 ) Th 2 + j 2 \cdot Tp 2 \\ where xi = \frac{QBi - QOi}{QAi + QBi - 2 QO i} , \qquad ( 13 )$$

and i is equal to 1 or 2.

The following formula is established for a case of a plurality of consecutive frames (assuming that there are w consecutive frames, where i is equal to 1, 2, . . . , or w):

$$( x 1 + m 1 ) Th 1 + j \cdot Tp 1 = ( x 2 + m 2 ) Th 2 + j 2 \cdot Tp 2 = … = xw + mwThw + jw \cdot Tpw \qquad ( 14 )$$

It may be understood that, when w=1, this case corresponds to the single-frequency full-period measurement solution described above. When w>1, the processing circuit may find out a ji combination with a minimum ti variance in modulation and demodulation frequencies, according to the remainder theorem or by traversing all ji combinations within a maximum measurement distance, as a solution value to complete the solution on ji. Then weighted averaging is performed on TOFs or measured distances that are solved under each group of frequencies to obtain a final TOF or measured distance. By using a multi-frequency modulation and demodulation method, a maximum measurement TOF is extended to:

$${t}_{max} = LCM ( {Tp}_{1} , {Tp}_{2} , … , {Tp}_{w} ) \qquad ( 15 )$$

A maximum measurement flight distance is extended to:

$${D}_{max} = LCM ( {D}_{max 1} , {D}_{max 2} , ⋯ , {D}_{maxw} ) \qquad ( 16 )$$

where Dmaxᵢ=C·Tpᵢ, and LCM represents obtaining a “lowest common multiple” (the “lowest common multiple” herein is a general expansion of a lowest common multiple in an integer domain, and LCM(a, b) is defined as a minimum real number that is divisible by real numbers a and b).

It is assumed that in the embodiment shown in FIG. 6, if Tp=15 ns, the maximum measurement flight distance is 4.5 meters (m), and if Tp=20 ns, the maximum measurement flight distance is 6 m. If the multi-frequency modulation and demodulation method is used, for example, in an embodiment, Tp1=15 ns and Tp2=20 ns, a lowest common multiple of 15 ns and 20 ns is 60 ns, a maximum measurement distance corresponding to 60 ns is 18 m, and a corresponding longest measurement target distance may reach 9 m.

It may be understood that, although in the embodiment shown in FIG. 6, a distance to the object is calculated according to data of at least two frames. In another embodiment, a two-consecutive-frame postponement manner may be used to avoid reduction of a quantity of frames to be acquired. FIG. 7 shows a two-consecutive-frame postponement acquisition method, according to an embodiment of this application. That is, for a case of performing measurement according to two consecutive frames in a double-frequency modulation and demodulation method to obtain a single TOF, a first TOF is calculated according to the first and second frames, a second TOF is calculated according to the second and third frames, and so on. In this case, a frame rate of the TOF is 1 frame less than the frame periods, thereby a measurement frame rate not being reduced.

The multi-frequency modulation and demodulation manner is also applicable to the noise-reduction TOF measurement solution shown in FIG. 3 or FIG. 4. FIG. 8(a) and FIG. 8(b) show schematic diagrams of a noise-reduction multi-frequency modulation and demodulation time of flight measurement method, according to an embodiment of this application. Using three taps as an example for description, a single macro period includes 3 frame periods. In each frame period, the processing circuit controls an acquisition sequence of the taps to change continuously or controls to emit a pulse beam with time delays according to a certain sequence, to enable the taps to alternately acquire charge signals, thereby reducing noise. To increase a measurement distance, different modulation and demodulation frequencies are used in two adjacent macro periods, such as f1 and f2 shown in FIG. 8(a), and combined with data of charge signals acquired in the two macro periods to calculate a TOF of the pulse beam and/or a distance from the camera to an object to be measured. The principle of the TOF measurement method is similar to formulas (12) and (13), and details are not described herein again.

In some embodiments, for the TOF depth camera to have a larger application range, a plurality of modulation and demodulation functions needs to be met. For example, the modulation and demodulation manner shown in FIG. 2 may be used to implement high frame rate measurement, and the modulation and demodulation manner shown in FIG. 3 or FIG. 4 may also be used to implement high precision measurement, where the two manners respectively correspond to a high frame rate measurement mode and a high precision measurement mode. Based on the two modes, a longer measurement range, namely, a large range measurement mode may be implemented through multi-frequency modulation. It may be understood that, frequency modulation needs to be implemented through a specific modulation driving circuit. The multi-frequency modulation manner shown in FIG. 7 and the multi-frequency modulation manner shown in FIG. 8(a) correspond to different modulation driving circuits, which means that, for a depth camera to meet this modulation solution, at least two groups of independent modulation driving circuits need to be set for control, thereby undoubtedly increasing the design difficulty and costs. Therefore, as shown in FIG. 8(b), high precision measurement may also be implemented by using the frequency modulation manner shown in FIG. 7. In this case, a macro period may be considered as being formed by an nth frame, an (n+2)th frame, and an (n+4)th frame. For example, starting from a first frame, the first frame, a third frame, and a fifth frame form a macro period, a second frame, a fourth frame, and a sixth frame form another adjacent macro period, and a TOF of a pulse beam and/or a distance from a camera to an object to be measured may be calculated by combining data of charge signals acquired in the two macro periods using different modulation and demodulation frequencies.

Similarly, to avoid reduction of a frame rate, a two-consecutive-frame postponement manner may be also used. As shown in FIG. 8, the first TOF is obtained through calculation according to data of signals acquired from the first frame to the sixth frame, the second TOF is obtained through calculation according to data of signals acquired from the second frame to the seventh frame, and so on. In this case, a frame rate of the TOF is five frames less than the frame period, thereby a measurement frame rate not being reduced.

It may be understood that, in the foregoing multi-frequency modulation and demodulation method, different measurement scenario requirements may be met by using different frequency combinations. For example, the accuracy of the final distance analysis may be improved by increasing a quantity of measurement frequencies. To dynamically meet measurement requirements in different measurement scenarios, in an embodiment of this application, the processing circuit adaptively adjusts the quantity of modulation and demodulation frequencies and a specific frequency combination according to feedback of result, to meet requirements in different measurement scenarios as much as possible. For example, in an embodiment, after a current distance to the object (or a TOF) is calculated, the processing circuit collects statistics on target distances. When most measurement target distances are relatively close, a relatively small quantity of frequencies may be used for measurement to ensure a relatively high frame frequency and to reduce the effect of the target movement on a measurement result. When there are a relatively large quantity of long-distance targets among the measurement targets, the quantity of measurement frequencies may be properly increased or a measurement frequency combination may be properly adjusted to ensure the measurement precision.

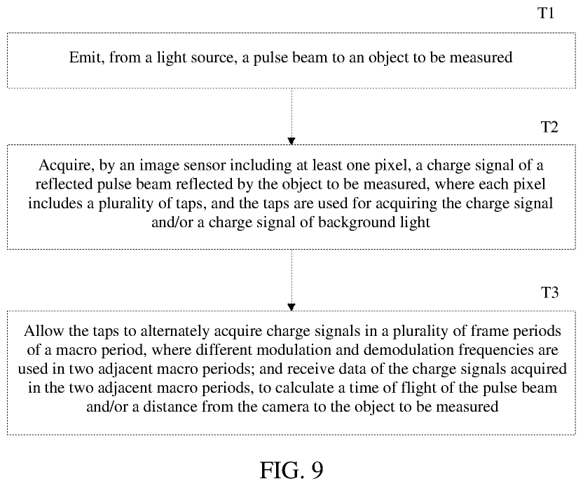

FIG. 9 shows a flow chart of a multi-frequency modulation and demodulation-based noise-reduction distance measurement method, including the following steps.

T1: emitting, from a light source, a pulse beam to an object to be measured.

T2: acquiring, by an image sensor including at least one pixel, a charge signal of a reflected pulse beam reflected by the object to be measured, where each pixel includes a plurality of taps, and the taps are used for acquiring the charge signal and/or a charge signal of background light.

T3: controlling the taps to alternately acquire charge signals in a plurality of frame periods of a macro period, where different modulation and demodulation frequencies are used in two adjacent macro periods; and receiving data of the charge signals acquired in the two adjacent macro periods, to calculate a time of flight of the pulse beam and/or a distance from the camera to the object to be measured.

In addition, for the method described in this application and content described in the embodiments, it should be noted that, for any three-tap or more-than-three-tap sensor-based single-frequency full-period measurement solution, noise-reduction measurement solution, and multi-frequency long distance measurement solution, the cases that a waveform of a modulation and demodulation signal within an exposure time range is continuous or discontinuous, or fine adjustment on a measurement sequence of modulation and demodulation signals with different frequencies, or fine adjustment on modulation frequencies in the same exposure time shall all fall within the protection scope of this application. Any embodiment description or analysis algorithm for explaining the principle of this application is only description of one of the embodiments of this application, and are not limitations on the content of this application. A person skilled in the art, to which this application belongs, may further make some equivalent replacements or obvious variations without departing from the concept of this application. Performance or functions of the replacements or variations are the same as those in this application, and all the replacements or variations fall within the protection scope of this application.

The beneficial effects achieved by this application are: resolving a conflict that the pulse width is in direct proportion to a measurement distance and power consumption, but is negatively correlated with the measurement precision in an existing PM-iTOF measurement solution. Therefore, the extension of the measurement distance is no longer limited by the pulse width. In a case of a longer measurement distance, lower measurement power consumption and higher measurement precision may still be retained. In addition, FPN caused by a mismatch between taps or between readout circuits due to manufacturing process errors or other reasons may be reduced or eliminated by alternating taps for acquisition. Compared with the CW-iTOF measurement solution, in this solution, for a single group of modulation and demodulation frequencies, one frame of depth information may be obtained by outputting a signal amount of three taps through one exposure, thereby significantly reducing the entire measurement power consumption and improving the measurement frame frequency. Therefore, this solution has apparent advantages compared with existing iTOF technical solutions.

All or some of the processes of the methods in the embodiments of this application may be implemented by a computer program instructing relevant hardware. The computer program may be stored in a computer-readable storage medium. During execution of the computer program by the processor, steps of the foregoing method embodiments may be implemented. The computer program includes computer program code. The computer program code may be in source code form, object code form, executable file, or some intermediate forms. The computer-readable medium may include: any entity or apparatus that is capable of carrying the computer program code, a recording medium, a USB flash drive, a removable hard disk, a magnetic disk, an optical disc, a computer memory, a read-only memory (ROM), a random access memory (RAM), an electric carrier signal, a telecommunication signal and a software distribution medium, and the like. It should be noted that, the content contained in the computer-readable medium may be appropriately increased or decreased according to the requirements of legislation and application practice in jurisdictions. For example, in some jurisdictions, according to legislation and patent practice, the computer-readable medium does not include an electric carrier signal and a telecommunication signal.

The foregoing contents are detailed descriptions of this application with reference to specific embodiments, and the specific implementation of this application is not limited to these descriptions. A person skilled in the art, to which this application belongs, may further make some equivalent replacements or obvious variations without departing from the concept of this application. Performance or functions of the replacements or variations are the same as those in this application, and all the replacements or variations fall within the protection scope of this application.

What is claimed is:

1. A depth camera, comprising:
a light source for emitting a pulse beam to an object to be measured;
an image sensor comprising at least one pixel, wherein each of the at least one pixel comprises a plurality of taps, and the plurality of taps are used for acquiring a charge signal generated by a reflected pulse beam reflected by the object to be measured and/or a charge signal of background light; and
a processing circuit, configured to:
control the plurality of taps to alternately acquire charge signals in a plurality of frame periods of a macro period, wherein different modulation and demodulation frequencies are used in two adjacent macro periods; and
receive data of charge signals acquired in the two adjacent macro periods to calculate a time of flight of the pulse beam and/or a distance from the depth camera to the object to be measured.

2. The depth camera according to claim 1, wherein the processing circuit is further configured to calculate the time of flight of the pulse beam in the macro period according to the following formula:
$$t = ( \frac{{Q}_{21} - {Q}_{31} + {Q}_{12} - {Q}_{22} + {Q}_{33} - {Q}_{13}}{{Q}_{21} + {Q}_{11} - 2 {Q}_{31} + {Q}_{12} + {Q}_{32} - 2 {Q}_{22} + {Q}_{33} + {Q}_{23} - 2 {Q}_{13}} ) Th$$
wherein Q₁₁, Q₂₁, Q₃₁, Q₁₂, Q₂₂, Q₃₂, Q₁₃, Q₂₃, and Q₃₃ respectively represent signals acquired by three taps of the plurality of taps in three consecutive frame periods of the plurality of frame periods.

3. The depth camera according to claim 1, wherein the processing circuit is further configured to control an acquisition sequence of the plurality of taps to change continuously or control a time delay in emitting the pulse beam by the light source to allow the plurality of taps to alternately acquire the charge signals.

4. The depth camera according to claim 3, wherein time delays between consecutive frame periods are regularly increased or regularly decreased, or irregularly changed; and a difference between the time delays between the consecutive frame periods is an integer multiple of a pulse width of the pulse beam.

5. The depth camera according to claim 1, wherein the processing circuit is further configured to identify the data of the charge signals to determine whether the data of the charge signals comprises the charge signal of the reflected pulse beam, generate a judgment result, and calculate the time of flight of the pulse beam and/or the distance from the depth camera to the object to be measured according to the judgment result.

6. A distance measurement method, comprising:
emitting, from a light source, a pulse beam to an object to be measured;
acquiring, by an image sensor comprising at least one pixel, a charge signal of a reflected pulse beam reflected by the object to be measured, wherein each of the at least one pixel comprises a plurality of taps, and the plurality of taps are used for acquiring the charge signal and/or a charge signal of background light; and
controlling the plurality of taps to alternately acquire charge signals in a plurality of frame periods of a macro period, wherein different modulation and demodulation frequencies are used in two adjacent macro periods; and receiving data of charge signals acquired in the two adjacent macro periods, to calculate a time of flight of the pulse beam and/or a distance from the depth camera to the object to be measured.

7. The distance measurement method according to claim 6, wherein the time of flight of the pulse beam in the macro period is calculated according to the following formula:
$$t = ( \frac{{Q}_{21} - {Q}_{31} + {Q}_{12} - {Q}_{22} + {Q}_{33} - {Q}_{13}}{{Q}_{21} + {Q}_{11} - 2 {Q}_{31} + {Q}_{12} + {Q}_{32} - 2 {Q}_{22} + {Q}_{33} + {Q}_{23} - 2 {Q}_{13}} ) Th$$
wherein Q₁₁, Q₂₁, Q₃₁, Q₁₂, Q₂₂, Q₃₂, Q₁₃, Q₂₃, and Q₃₃ respectively represent signals acquired by three taps of the plurality of taps in three consecutive frame periods of the plurality of frame periods.

8. The distance measurement method according to claim 6, wherein the controlling the plurality of taps to alternately acquire charge signals in a plurality of frame periods of a macro period comprises: controlling an acquisition sequence of the plurality of taps to change continuously or controlling a time delay in emitting the pulse beam by the light source to allow the plurality of taps to alternately acquire the charge signals.

9. The distance measurement method according to claim 6, wherein time delays between consecutive frame periods are regularly increased, regularly decreased, or irregularly changed; and a difference between the time delays between the consecutive frame periods is an integer multiple of a pulse width of the pulse beam.

10. The distance measurement method according to claim 6, further comprising:
identifying the data of the charge signals to determine whether the data of the charge signals comprises the charge signal of the reflected pulse beam;
generating a judgment result; and
calculating the time of flight of the pulse beam and/or the distance from the depth camera to the object to be measured according to the judgment result.
